(19) United States
(12) Patent Application Publication
(10) Pub. No.: US 2026/0145169 A1
(43) Pub. Date: May 28, 2026

(54) Modular Strip-Well Assay Kits with Preloaded Reagents

(71) Applicant: Nicholas Chacos, Milpitas, CA (US)

(72) Inventor: Nicholas Chacos, Milpitas, CA (US)

(21) Appl. No.: 19/380,203

(22) Filed: Nov. 5, 2025

Related U.S. Application Data
(60) Provisional application No. 63/724,999, filed on Nov. 26, 2024.

(51) Int. Cl. B01L 3/00

(52) U.S. Cl. CPC B01L 3/5023; B01L 3/5025; B01L 2200/148; B01L 2200/16; B01L 2300/044; B01L 2300/0825; B01L 2300/0829

(57) ABSTRACT

A ready-to-use assay kit for modular strip-well plates employs detachable strips whose wells contain co-located, mutually reactive reagents kept apart during storage by an in-well sequestration structure that encapsulates at least one reagent. Upon addition of an aqueous sample, buffer, or water, the structure releases (e.g., rupturable capsules/microcapsules or a phase-change encapsulant), enabling in-well mixing to form a reaction mixture that yields a detection signal. The kit is configured to operate without transfer of reagents between wells prior to reading. Optional features include in situ lyophilization with lyoprotectants, controlled residual moisture, and an inert-gas headspace. Calibrator and control strips may be provided. Detection can be by absorbance, fluorescence, or luminescence using a plate reader.

### CROSS-REFERENCE TO RELATED APPLICATIONS

This application claims the benefit of U.S. Provisional Patent Application No. 63/724,999, filed on Nov. 26, 2024, under 35 U.S.C. § 119(e). The entire contents of that provisional application are incorporated herein by reference.

### BACKGROUND

### Technical Field

This disclosure relates to in vitro analytical assays and microplate consumables. It concerns ready-to-use test kits configured for use with modular strip-well plates having detachable strips. The subject matter includes reagent handling, storage, release, and optical signal readout (e.g., absorbance, fluorescence, luminescence).

### Description of the Related Art

Plate-based assays commonly use 96- or 384-well formats. Users prepare reagents, perform serial dilutions, carry out timed additions and incubations, and then read optical signals. Although prefilled or dried-reagent plates exist, many designs keep reactive components in different wells and require inter-well transfers before reading. Modular strip formats are known, but contents are often fixed and multistep workflows still involve multiple liquid moves. There remains a need for self-contained wells in modular, detachable strips that store multiple mutually reactive components together yet prevent premature reaction, enabling direct addition of liquid and reading without any inter-well transfer.

### SUMMARY

This disclosure provides assay kits and methods for modular strip-well plates with detachable strips in which multiple reagents are co-located in the same well and kept apart during storage by an in-well sequestration structure that encapsulates at least one reagent or spatially separates reagents within the well. Upon addition of an aqueous sample, buffer, or water, the structure releases (e.g., by rupturing capsules/microcapsules or by softening/melting a phase-change encapsulant) so the reagents mix in the same well and form a reaction mixture that yields a detection signal.

The kits are ready-to-use and are configured to operate without transfer of reagents between wells prior to reading. Optional features include in situ lyophilization with lyoprotectants (e.g., trehalose, mannitol, sucrose), controlled residual moisture, and inert-gas headspace. Detachable calibrator and control strips can be provided. Detection can be by absorbance, fluorescence, or luminescence using a plate reader.

### BRIEF DESCRIPTION OF THE DRAWINGS

FIG. 1 is an assembled overview of a kit (100) showing a frame (110) configured to receive multiple detachable strips (200), each having wells (212).

FIG. 2 is a plan view of a strip (200) with a body (202), a well array region (210) including wells (212), a rim/land (214) to accept a removable seal (320), and coupling features (216) to seat and remove the detachable strip in/from the frame (110).

FIG. 3 is a cross-sectional view of a well (212) containing premeasured, mutually reactive reagents (330a, 330b) co-located in the same well, with at least one reagent held in a rupturable capsule (350) or microcapsules (352) that release upon hydration. A removable seal (320) closes the well. A headspace (340) can include an inert gas.

FIG. 4 is a cross-sectional view of a well (212) in which a phase-change encapsulant (360) surrounds at least one reagent and softens/melts at an incubation temperature to permit in-well mixing; no physical partitioning of the well volume is required.

FIG. 5 is a schematic plate layout showing a frame (110) with user-selectable, detachable strips, including calibrator strips (402), control strips (404), and sample strips (406). Assays proceed by in-well reactions without inter-well transfers prior to reading.

### DETAILED DESCRIPTION

The drawings are schematic and not to scale. Like reference numerals refer to like elements throughout the figures. The examples below illustrate representative configurations and are not limiting.

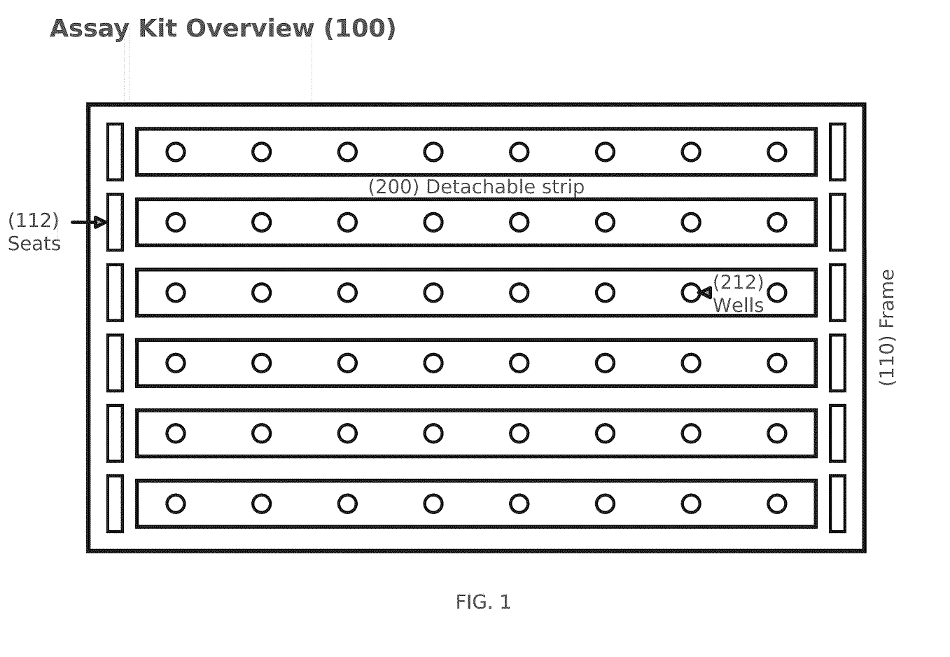

Referring to FIG. 1, a kit overview (100) includes a frame (110) configured to receive multiple detachable strips (200). Each strip includes a well array region (210) with wells (212). Commercially available modular strip-well plates and frames may be used.

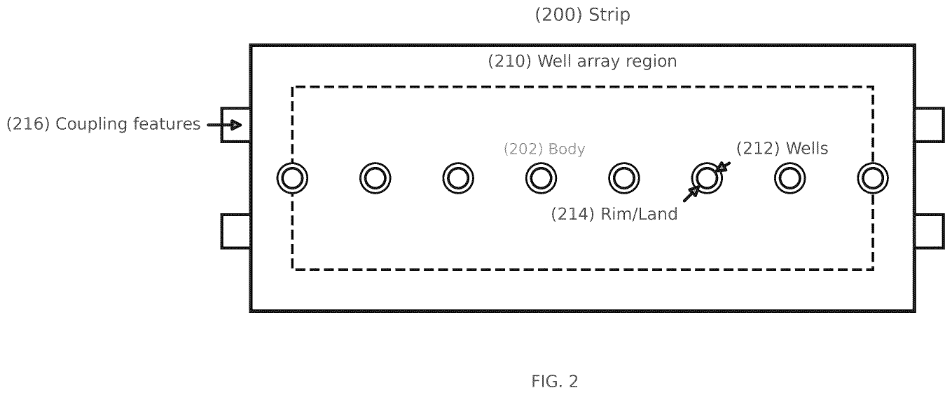

Referring to FIG. 2, a strip (200) having a body (202) carries eight wells (212) in the well array region (210). A rim or land (214) surrounds each well (212) to accept a removable seal (320). Coupling features (216) engage the frame (110) to support seating and removal of the detachable strip (200).

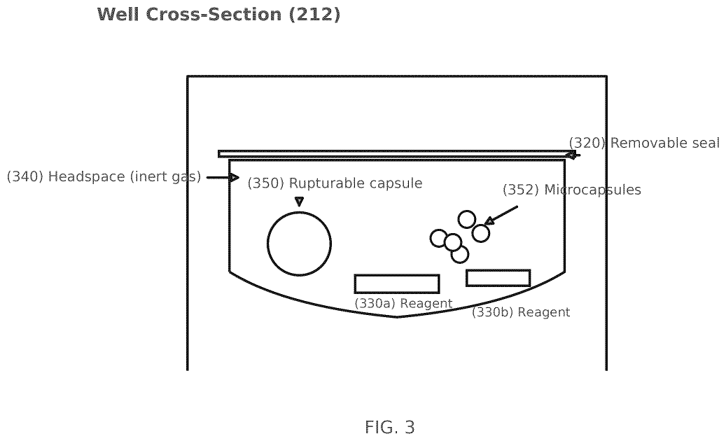

Referring to FIG. 3, a cross-section of a well (212) shows premeasured reagents (330a, 330b) co-located in the same well. The reagents are mutually reactive so that, upon release and mixing, a detectable signal is generated in the same well. At least one reagent is contained in a rupturable capsule (350) or microcapsules (352) that release upon hydration by an added liquid (e.g., aqueous sample, buffer, or water). The well is closed by a removable seal (320) that protects contents during storage. In some versions, a headspace (340) includes an inert gas (e.g., nitrogen, argon, or another inert gas) to improve stability of oxygen-sensitive components. The sequestration is by encapsulation within the well and does not require any physical partition of the well. Upon dissolution/release, the entire well volume functions as the reaction zone.

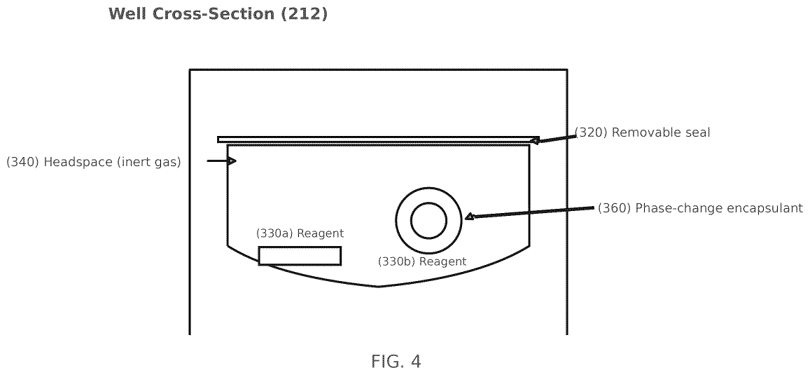

Referring to FIG. 4, another version uses a phase-change encapsulant (360) surrounding at least one reagent. The encapsulant softens or melts at an incubation temperature, permitting mixing of reagents in the same well. This encapsulation is within the well; no physical partitioning of the well volume is required. After release, the entire well volume functions as the reaction zone. In another variant (not shown), multiple reagents are deposited at spaced-apart locations within the same well without encapsulation; upon addition of an aqueous sample, buffer, or water, the dried deposits dissolve and commingle to form the reaction mixture in the same well.

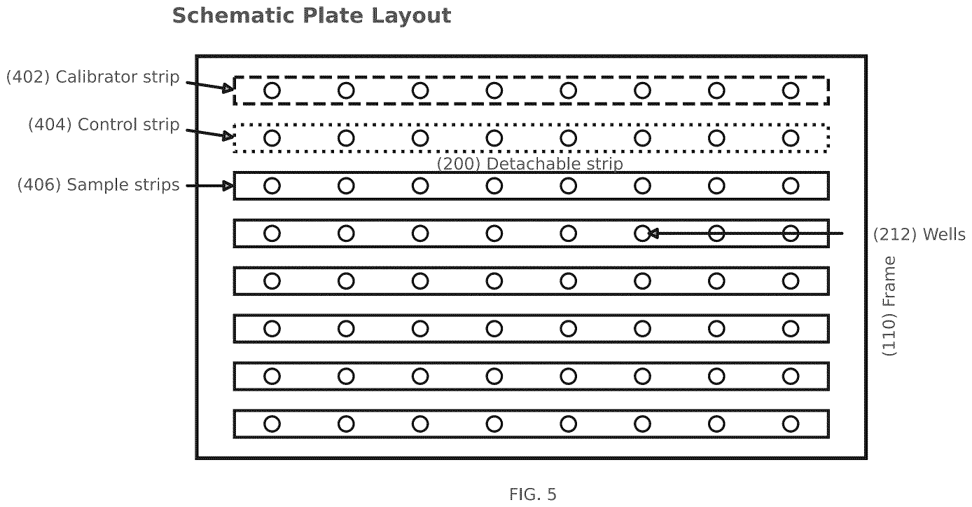

Referring to FIG. 5, a schematic plate layout shows a frame (110) with user-selectable, detachable strips. Calibrator strips (402) can provide known levels, control strips (404) can provide blanks, positive controls, or negative controls, and sample strips (406) receive unknowns. Assays proceed by in-well reactions without inter-well transfers prior to reading.

Commercially available modular strip-well plates and frames may be used. The disclosure is not limited to particular plate polymers, molding details, or strip geometry. The number of wells per strip may vary (e.g., 8, 12, or other counts), provided that the strips are detachable and seat in the frame (110).

Each well can be covered by a removable seal (320), such as a peelable film or a pierceable foil. A headspace (340) may include an inert gas (e.g., nitrogen, argon, or another inert gas) to improve stability during storage.

In-well sequestration maintains reactive components apart during storage and releases them at run time. As used here, sequestration structure includes functional implementations such as (i) encapsulation of at least one reagent (e.g., rupturable capsules or microcapsules that release upon hydration, or a phase-change encapsulant that softens or melts at an incubation temperature) and (ii) spatial separation of reagents within the well, for example by depositing dried reagent charges at spaced-apart regions of the well floor or sidewall so they remain isolated until hydrated.

Reagents (330a, 330b) may include enzymes, substrates, inhibitors, cofactors, buffers, and standards. In situ lyophilization can form cakes within the well. Example lyoprotectants include trehalose, mannitol, and sucrose, alone or in combination. Residual moisture may be controlled, for example between 0.2 percent and 2.0 percent by weight.

Kits may be packaged in moisture-barrier pouches with desiccant and a moisture indicator. An inert purge may be used before sealing. Labels may list storage conditions and expiration.

A user selects a subset of detachable strips for a run, optionally including calibrator strips (402) and control strips (404). The user seats strips in the frame (110), opens the removable seal (320) of a target well (212), and adds an aqueous sample, buffer, or water. Hydration ruptures capsules or softens/melts a phase-change encapsulant, allowing reagents to mix in the same well. After incubation as needed, a signal is read with a plate reader. No transfer of reagents between wells is performed prior to reading. Detection can be by absorbance, fluorescence, or luminescence.

Reagents can be dispensed into wells (212) under controlled humidity, lyophilized in situ, and then encapsulated as needed (capsules/microcapsules or phase-change coatings). A removable seal (320) is applied. Assemblies may be pouched with desiccant and a moisture indicator. Quality checks can include residual moisture, seal integrity, and functional release of encapsulated reagents.

Strips can include more or fewer than eight wells. The frame can be single-use or reusable. Triggers for release can be hydration, temperature, or combinations thereof. Equivalent materials and structures that achieve in-well sequestration during storage and release during the assay are within the scope of this disclosure.

Samples may be biological, chemical, or environmental. Example matrices include serum, plasma, lysate, water, and food extracts. Assays may include enzyme activity, inhibitor screening, biomarker detection, or diagnostic panels

What is claimed is:

1. An assay kit comprising:
a modular strip-well plate including a plurality of detachable strips, each strip comprising a plurality of wells;
at least one well containing a premeasured set of mutually reactive reagents co-located in the same well;
a sequestration structure within said at least one well configured to maintain separation of at least one reagent from at least one other reagent during storage, the sequestration structure comprising encapsulation of at least one reagent or spatial separation of reagents within the well; and
a removable seal covering said at least one well;
wherein, upon addition of an aqueous sample, buffer, or water to said at least one well, said sequestration structure releases to permit said reagents to mix in the same well to form a reaction mixture that yields a detection signal; and
wherein the kit is ready-to-use and configured to operate without transfer of reagents between wells prior to reading said detection signal.

2. The assay kit of claim 1, wherein said sequestration structure comprises a rupturable capsule or microcapsules that release upon hydration.

3. The assay kit of claim 1, wherein said sequestration structure comprises a phase-change encapsulant that softens or melts at an incubation temperature to allow mixing in said well.

4. The assay kit of claim 1, wherein said reagents are dried in situ by lyophilization with a lyoprotectant selected from trehalose, mannitol, sucrose, and combinations thereof.

5. The assay kit of claim 4, wherein a residual moisture content of the dried reagents in said well is between 0.2 percent and 2.0 percent by weight.

6. The assay kit of claim 1, wherein said removable seal is a peelable film or a pierceable foil.

7. The assay kit of claim 1, further comprising at least one strip preloaded with calibrators and at least one strip preloaded with control reagents selected from blank, positive control, and negative control.

8. The assay kit of claim 1, wherein said at least one well is sealed under an inert gas.

9. The assay kit of claim 1, wherein said detection signal is measured by absorbance, fluorescence, or luminescence using a plate reader.

10. The assay kit of claim 1, wherein said aqueous sample is a biological, chemical, or environmental sample.

11. A method of performing an assay comprising:
selecting a subset of detachable strips of a modular strip-well plate;
opening a removable seal of a target well that contains a premeasured set of mutually reactive reagents and a sequestration structure that encapsulates at least one reagent;
adding an aqueous sample, buffer, or water to said target well;
releasing said encapsulated reagent to permit mixing and form a reaction mixture in said well;
incubating as needed; and
detecting a signal from said well;
wherein the method is performed without transfer of reagents between wells prior to said detecting.

12. The method of claim 11, wherein said releasing comprises rupturing a capsule or microcapsules upon hydration.

13. The method of claim 11, wherein said releasing comprises softening or melting a phase-change encapsulant at an incubation temperature.

14. The method of claim 11, wherein said detecting comprises measuring absorbance, fluorescence, or luminescence with a plate reader.
